(19) United States
(12) Patent Application Publication
(10) Pub. No.: US 2009/0065310 A1
(43) Pub. Date: Mar. 12, 2009

(54) INSTALLING GUIDE RAILS IN AN ELEVATOR SYSTEM

(76) Inventors: Michael P. Flynn, Avon, CT (US); Ken Woronoff, Portland, CT (US); Charles Darling, New Britain, CT (US); Stanley P. Urban, Newtown, CT (US)

Correspondence Address: CARLSON GASKEY & OLDS, 400 W MAPLE STE 350, BIRMINGHAM, MI, 48009, US

(21) Appl. No.: 11/719,402

(22) PCT Filed: Nov. 16, 2004
(86) PCT No.: PCT/US04/38370

§ 371 Date: May 16, 2007

(51) Int. Cl. B66B 7/02

(52) U.S. Cl. 187/408; 52/741.1

(57) ABSTRACT

A device (50) facilitates installing elevator guide rails (30) within a hoistway (22) after at least a few doorways (40) have been installed. A selected doorway member (42) provides a guide or reference for positioning the guide rails (30). The device (50) includes a first portion (52) adapted to be selectively positioned relative to the selected doorway member (42) and a second portion (54) that holds corresponding sections of the guide rails (30) in a desired position and alignment relative to the selected doorway member (42).

### FIELD OF THE INVENTION

This invention generally relates to elevator systems. More particularly, this invention relates to installing guide rails in an elevator system.

### DESCRIPTION OF THE RELATED ART

Elevator systems typically include an elevator car that travels in a vertical direction within a hoistway. Guide rails are positioned within the hoistway to guide movement of the elevator car. Guide rollers supported on the elevator car assembly follow along the guide rails in a known manner.

Part of the challenge to efficiently and economically installing elevator systems involves installing the guide rails. A typical installation procedure includes building the hoistway, installing the guide rails and subsequently using an elevator platform moving along the guide rails to install doorway components to provide appropriate alignment between the doorway components and the elevator car that will be traveling along the guide rails. This process is time-consuming. Moreover, installation of the doorway components is required before another contractor can complete installation of certain interior building materials such as the doorway surrounds and finished flooring. These typically must wait until after the elevator doorway components are installed. Accordingly, certain inefficiencies during a building process typically are experienced.

There is a need for an alternative arrangement to simplify the arrangement of the guide rails and to facilitate more efficient building practices. This invention addresses those needs.

### SUMMARY OF THE INVENTION

An example device that is useful for installing guide rails in an elevator system includes a first portion that is adapted to be selectively positioned relative to a previously installed doorway member. A second portion holds a corresponding section of at least one guide rail in a selected location relative to the doorway member.

One example device comprises a frame having the first portion near one end with at least one surface for engaging the doorway member. The second portion is near an opposite end of the frame and has at least one surface for holding the corresponding guide rail section.

One example includes securing members for holding the device in place relative to the doorway member. In one example, the sill member is used as the reference point for locating the device and the guide rails because the sill member typically has the most critical relationship to the position of the elevator car within the hoistway.

An example method of installing guide rails in an elevator system includes installing a plurality of doorway members at each of a plurality of landings. The method includes positioning guide rails into a desired position based on the position of at least one of the doorway members associated with at least some of the landings.

The various features and advantages of this invention will become apparent to those skilled in the art from the following detailed description of a currently preferred embodiment. The drawings that accompany the detailed description can be briefly described as follows.

### BRIEF DESCRIPTION OF THE DRAWINGS

FIG. 1 schematically shows selected portions of an elevator system.

FIG. 2 schematically shows an example device for installing guide rails in an elevator system.

FIG. 3 is a top plan view of the embodiment of FIG. 2.

FIG. 4 is a side view of selected portions of the embodiment of FIGS. 2 and 3.

FIG. 5 is a side view of selected portions of the embodiment of FIGS. 2 and 3, schematically showing an adjustment feature.

### DETAILED DESCRIPTION OF THE PREFERRED EMBODIMENT

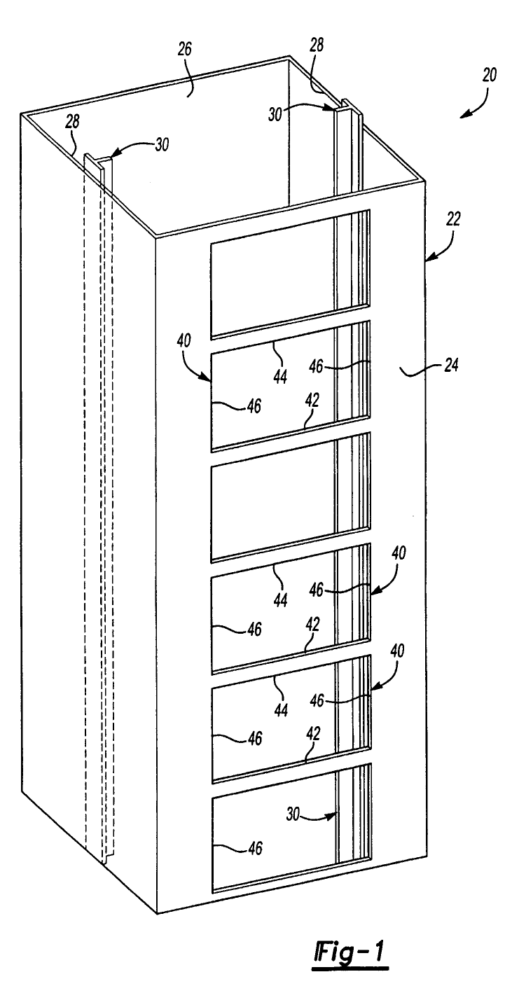

FIG. 1 schematically shows selected portions of an elevator system 20. A hoistway 22 includes a front wall 24, a rear wall 26 and sidewalls 28. Guide rails 30 are supported in a known manner relative to the sidewalls 28.

A plurality of doorways 40 provide entrance to the hoistway 22. The doorways 40 are associated with each of the landings that will eventually be serviced by the elevator system.

Each doorway 40 includes a plurality of doorway members such as a sill member 42, a header member 44 and jamb members 46.

According to one example installation technique, the doorway members 42, 44 and 46 are installed prior to installing the guide rails 30. This allows for using a different technique to position the guide rails 30 within the hoistway 22. Installing the doorways 40 before the guide rails 30 also allows for other contractors to continue with construction work while the elevator system is still being installed.

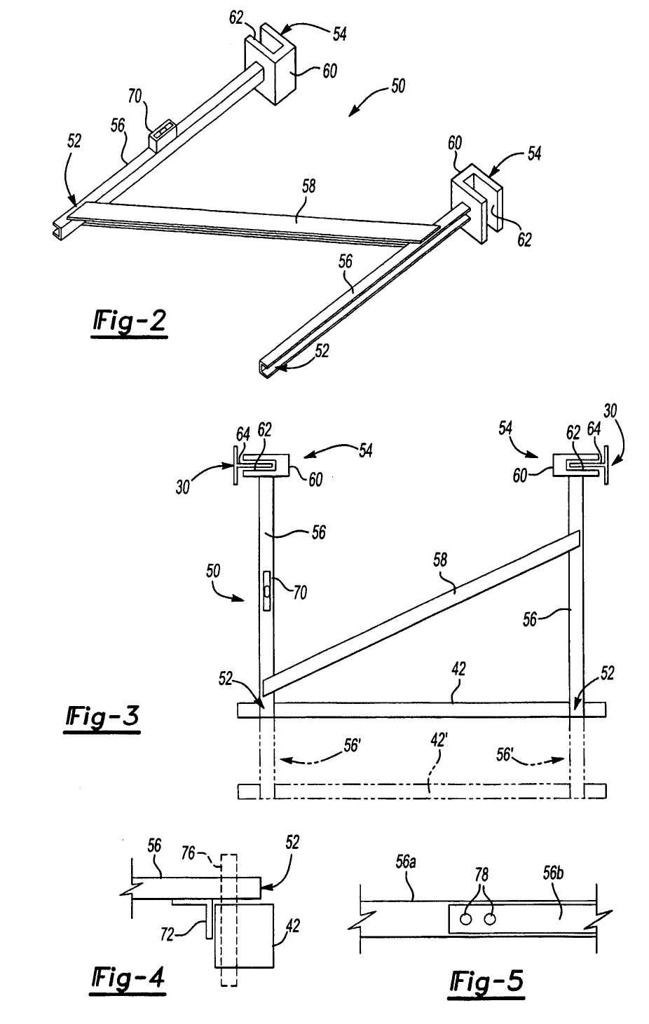

FIG. 2 schematically shows an example device 50 that is useful for positioning the guide rails 30 within the hoistway 22 based upon the position of at least one of the doorway members of at least some of the doorways 40 that have already been installed. The example device 50 includes a first portion 52 that is adapted to be selectively positioned relative to at least one of the doorway members. A second portion 54 is adapted to hold a corresponding section of the guide rails 30 in an appropriate position relative to the selected doorway member so that the guide rails 30 can be secured in place relative to the hoistway walls 28, for example. In one example, known guide rail mounting brackets are used for securing the guide rails 30 in place within the hoistway 22.

The example of FIG. 2 includes a frame having elongated members 56 with a generally elongated stabilizing member 58 extending between the elongated members 56. The stabilizing member 58 maintains a squared, stable position of the elongated members 56 relative to each other. The elongated members 56 preferably are maintained parallel to each other to provide for accurate positioning of the guide rails 30 relative to the selected doorway member.

In the example of FIG. 2, the first portion 52 is located near one end of the elongated members 56. The second portion 54 in this example is located near an opposite end of the elongated members 56.

In the illustrated example, holding members 60 are supported near the ends of the elongated members 56 that are distal from the selected doorway member used as a guide rail positioning reference. The holding members 60 in this example include slots 62 that are sized to receive a blade portion 64 of the guide rails 30. As can be appreciated from FIGS. 2 and 3, the slots 62 in this example have openings facing in opposite directions to accommodate the oppositely facing guide rail blade portions 64.

The illustrated example includes a level indicator 70 that provides a visual indication of the horizontal or level position of the device 50 to facilitate accurate placement of the guide rails 30.

In one example, the first portion 52 is adapted to contact an appropriate portion of a sill member 42 at each of the selected doorways used to position the guide rails 30 in place. In such an example, the sill member 42 will be pre-installed in a level and plum orientation relative to the other sill members associated with the hoistway 22. By having the distance between the first portion 52 and the second portion 54 remain fixed and aligning the device 50 in a level position (as indicated by the indicator 70) at several of the doorways, an appropriate alignment of the guide rails 30 relative to the hoistway entrances or doorways 40 can be readily accomplished using the illustrated example device.

FIG. 4 schematically shows one example where a locating feature 72 facilitates accurately locating the first portion 52 relative to a selected sill member 42. In this example, the locating feature 72 comprises a generally L-shaped bracket secured near one end of each elongated member 56. As can be appreciated from the drawing, one surface of the elongated members 56 and the positioning feature 72 are received against the sill member 42 in a manner that allows manipulation of the second portion 54 into an appropriate orientation to correctly position the corresponding sections of the guide rails 30.

The example of FIG. 4 includes a securing member 76 for securing the first portion 52 in the desired location relative to the sill member 42 during the installation process at the corresponding landing.

One example installation device 50 has an adjustable length feature that allows it to be used in various elevator systems to accommodate different distances between sill members and corresponding guide rails, for example. As shown in phantom in FIG. 3, the elongated members 56 of the example of FIG. 3 can be selectively lengthened or shortened to accommodate different needs of different installations. When the sill member 42′ is at a further distance from the guide rails 30 than the sill member 42, the elongated members 56 can be lengthened as shown at 56′ to accommodate such a situation.

FIG. 5 schematically shows a telescoping arrangement between elongated member portions 56A and 56B. Locking members 78 secure the telescoping portions in a selected position to maintain the same distance between the first portion 52 and the second portion 54 throughout the entire installation process for a given set of guide rails 30. In one example, the locking members 78 comprise nuts and bolts received through corresponding openings in the telescoping portions of the elongated members 56.

The disclosed example has the advantage of allowing for installing guide rails after elevator doorway components are installed. Provided that at least a sill member of at least some of the doorways has been appropriately installed, the illustrated example can be used to more efficiently install elevator guide rails in an accurate manner. For example, sequentially moving from top-to-bottom or simultaneously positioning various sections of the guide rails makes installation more efficient. The illustrated example also provides the advantage of allowing other contractors to continue with building construction techniques prior to completing as much of the elevator system installation as had been required in the past.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-15. (canceled)

16. A device for installing guide rails for an elevator system, comprising:
a frame including
a first portion near one end with at least one surface for engaging a previously installed doorway member; and
a second portion near an opposite end with at least one surface for holding a corresponding section of at least one guide rail in a selected location relative to the doorway member such that a fixed distance between the first and second portions is operative to align the guide rail relative to the doorway member at each of a plurality of doorways along a hoistway when the first portion engages the doorway member at each of the doorways.

17. The device of claim 16, wherein the frame comprises two spaced apart, generally parallel elongated members having the first portion near one end and the second portion near an opposite end.

18. The device of claim 17, wherein the second portion comprises holding members supported near the opposite ends of the elongated members, respectively, each holding member comprising a slot sized to receive the corresponding guide rail section.

19. The device of claim 17, including a level indicator that provides an indication that the elongated members are in a desired orientation relative to the doorway member.

20. The device of claim 17, wherein the elongated members have a selectively adjustable length.

21. The device of claim 20, including a locking member for locking the elongated members into a selected length.

22. The device of claim 16, including a securing member for securing the first portion into a selected position relative to the doorway member.

23. The device of claim 16, including a level indicator that provides an indication of a level position of the device.

24. The device of claim 16, wherein the second portion includes a plurality of holding members, each including a slot for receiving the corresponding guide rail section.

25. The device of claim 24, wherein one slot is open in an oppositely facing direction relative to another one of the slots.

26. The device of claim 16, wherein the frame comprises a stabilizing member extending between the generally parallel elongated members.

27. A method of installing guide rails in an elevator system using a device that has a first portion for engaging a doorway member and a second portion for holding a corresponding section of the guide rails, comprising the steps of:
installing at least one doorway member at a plurality of landings along a hoistway;
fixing a distance between the first and second portions of the device;
engaging the first portion with a selected doorway member at two or more of the landings to which the at least one doorway member is installed; and
positioning guide rails into a desired position based on the fixed distance while the first portion is engaged with the selected doorway member at each of the two or more landings to which the at least one doorway member is installed.

28. The method of claim 27, including selecting, as the selected doorway member, an installed sill member at each of the two or more landings to which the at least one doorway member is installed.

29. The method of claim 27, including beginning near one end of the guide rails and sequentially moving toward an opposite end of the guide rails, using the doorway members and the device.
